(19) United States
(12) Patent Application Publication
(10) Pub. No.: US 2008/0267045 A1
(43) Pub. Date: Oct. 30, 2008

(54) Laser driving method and optical disc recording/reproducing device

(76) Inventors: Junji Nakajima, Yokohama (JP); Kazuhiro Ikeda, Kawasaki (JP); Nobuo Nakai, Yokohama (JP)

Correspondence Address: MCDERMOTT WILL & EMERY LLP, 600 13TH STREET, N.W., WASHINGTON, DC, 20005-3096, US

(21) Appl. No.: 12/078,450

(22) Filed: Mar. 31, 2008

(30) Foreign Application Priority Data
Apr. 27, 2007 (JP) 2007-117959

(51) Int. Cl. G11B 7/00

(52) U.S. Cl. 369/116

(57) ABSTRACT

A laser driving method and an optical disc recording/reproducing apparatus are provided which are arranged to stably write data on an optical disc. The laser driving method is applied to a laser driving circuit arranged to have a laser diode for emitting a laser beam onto an optical disc, a transistor connected in series with the laser diode and a variable power supply for applying a DC voltage to the laser diode. The laser driving method includes the steps of causing the laser diode to emit a laser beam on trial before starting recording of data on the optical disc, detecting an operating voltage applied onto a contact between the laser diode and the transistor, and adjusting a DC voltage of the variable power supply based on the operating voltage.

### INCORPORATION BY REFERENCE

The present application claims priority from Japanese application JP 2007-117959 filed on Apr. 27, 2007, the content of which is hereby incorporated by reference into this application.

### BACKGROUND OF THE INVENTION

1. Field of the Invention

The present invention relates to a method for driving a laser diode loaded in an optical disc recording/reproducing apparatus.

2. Description of the Related Art

An example of a commonly available driving circuit for driving a laser diode 1 loaded in an optical disk recording/reproducing apparatus is illustrated in FIG. 3. The laser diode 1 is characterized in that the driving current or the driving voltage Vop required for obtaining a necessary emission power varies depending upon the change of the ambient temperature around the diode 1 and the aging thereof. The changes of the characteristics of the driving current verses the driving voltage of the laser diode depending upon the temperatures are exemplarily illustrated in FIG. 4.

The output voltage of a laser driving power supply 25 is required to be set such a high value as ensuring the driving voltage Vop of the laser diode 1 and the operating voltage V3 of the driving transistor 3. In particular, when recording data onto an optical recording medium, the laser diode is required to output a high emission power. Hence, the driving voltage Vop becomes high accordingly. The laser driving power supply is thus required to have quite a high output voltage.

To cope with such a high output voltage, the laser diode driving circuit may be designed so that the laser driving power supply 25 is capable of outputting a surplus voltage. However, the laser driving power supply 25 consumes more power according to the surplus. That is, the trade-off relation takes place between the surplus voltage and the power consumption of the power supply 25.

The Official Gazettes of the JP-A-Hei11-213426 and the JP-A-2006-185997 disclose the laser driving circuits designed to solve the foregoing trade-off relation. These circuits are designed to detect an operating voltage V3 of the driving transistor and to adjust the output voltage of the laser driving power supply 25 so that the operating voltage reaches the predetermined value. This design allows the power consumption to be reduced as ensuring the operating voltage V3.

Further, the Official Gazette of the JP-A-2006-85754 discloses the method for performing the foregoing adjustment when recording data. US 2002/0131358 discloses the method for performing the foregoing adjustment when turning on the apparatus or inserting an optical disc to the apparatus.

### SUMMARY OF THE INVENTION

However, the foregoing prior arts have been arranged to use the voltage adjusted when turning on the apparatus or inserting an optical disc for a driving voltage to be set in starting the recording operation. This arrangement thus causes the variation of the voltage Vop based on the temperature change on time to appear as an error. As the time passes, therefore, the optimal laser power cannot be used for writing data when starting the recording operation.

It is an object of the present invention to provide a laser driving method and an optical disc recording/reproducing apparatus which are arranged to stably write data on an optical disc.

In carrying out the foregoing object, according to a first aspect of the invention, a method for driving a laser driving circuit having a laser diode for emitting a laser beam onto an optical disc, a transistor connected in series with the laser diode, and a variable power supply for applying a DC voltage into the laser diode, includes the steps of causing the into the laser diode, includes the steps of causing the laser diode to emit a laser beam on trial before starting recording of data onto an optical disc; detecting an operating voltage on a contact between the laser diode and the transistor, and adjusting the DC voltage of the variable power supply based on the detected operating voltage.

The laser driving method according to an aspect of the invention is arranged to cause the laser diode to emit a laser beam on trial, for example, before starting recording of data onto an optical disc so as to determine if the laser diode is driven in a desired operating state, and, if not, adjust the voltage or the current to be supplied to the laser diode.

### BRIEF DESCRIPTION OF THE DRAWINGS

FIG. 1 is a schematic block diagram showing an optical disc recording/reproducing apparatus according to the present invention;

FIG. 2 shows the operation waveforms of various kinds of signals appearing in the normal recording interval and in the APC area interval;

FIG. 3 is an explanatory view exemplarily showing an arrangement of a laser driving circuit;

FIG. 4 is a graph showing the current versus voltage characteristics on the temperatures of a blue-violet laser diode;

FIG. 5 is a flowchart showing a process for adjusting an operating voltage of the driving transistor;

FIG. 6 is a flowchart showing a process for adjusting an operating voltage of a driving transistor;

FIG. 7 is an explanatory view showing the operation waveforms in the APC area interval during the recording operation;

FIG. 8 is an explanatory view showing the operation waveforms in the APC area interval during the recording operation;

FIG. 9 is an explanatory view showing the operation waveforms in the APC area interval during the recording operation; and

FIG. 10 is a graph showing relation between a light emission power and an operating voltage of the driving transistor.

### DESCRIPTION OF THE EMBODIMENTS

Hereafter, the description will be oriented to a laser driving method and an optical disc recording/reproducing apparatus according to an embodiment of the present invention.

The laser driving method according to the embodiment of the invention is arranged to cause the laser diode to emit a laser beam on trial (that is, cause the laser diode to be experimentally active for light emission) before starting recording of data so as to adjust an operating voltage of the driving transistor. Since the laser diode varies its driving voltage depending upon the aging and the temperature characteristic, some shift may take place in the relation between the DC voltage to be applied to the laser diode in shipping or turning on the apparatus and the operating voltage of the driving transistor corresponding with the DC voltage. In this embodiment, however, before staring the recording of data, for example, before writing data on trial, the laser diode to be caused to emit a beam on trial so as to adjust the operating voltage of the driving transistor. This operation causes the shift, if any, to be adjusted before writing data on trial or recording data. Hence, the laser driving method makes it possible to shift the operation of the laser diode to the stable recording operation.

Further, the trial activation of the laser diode may be executed before starting recording of data as well as during the recording operation.

In this laser driving method, when an optical disc is loaded to the drive, in order to prevent erroneous recording of data onto the optical disc, it is preferable to keep an objective lens sufficiently off the optical disc when the laser diode is caused to emit a beam on trial, rotate the optical disc, or shift the radiation position of a laser beam to a non-recording area of the optical disc.

Further, when the laser diode is caused to emit a beam on trial during the recording of data onto an optical disc, it is preferable to measure the operating voltage of the driving transistor 3 at some lower powers of the trial light emission of the laser diode than the peak power thereof and then to estimate the operating voltage of the driving transistor 3 caused when outputting the peak power by an approximation.

When the laser diode is caused to emit a beam on trial during the recording of data onto an optical disc, it is possible to use a different emission waveform from the emission waveform in recording data.

The most preferable laser diode to be driven by the laser driving method according to the invention is a blue-violet laser diode.

Hereafter, the laser driving method and the optical disc recording/reproducing apparatus according to the embodiments of the present invention will be described in more detail with reference to the appended drawings. However, the present invention is not defined by the following embodiments.

### Embodiment 1

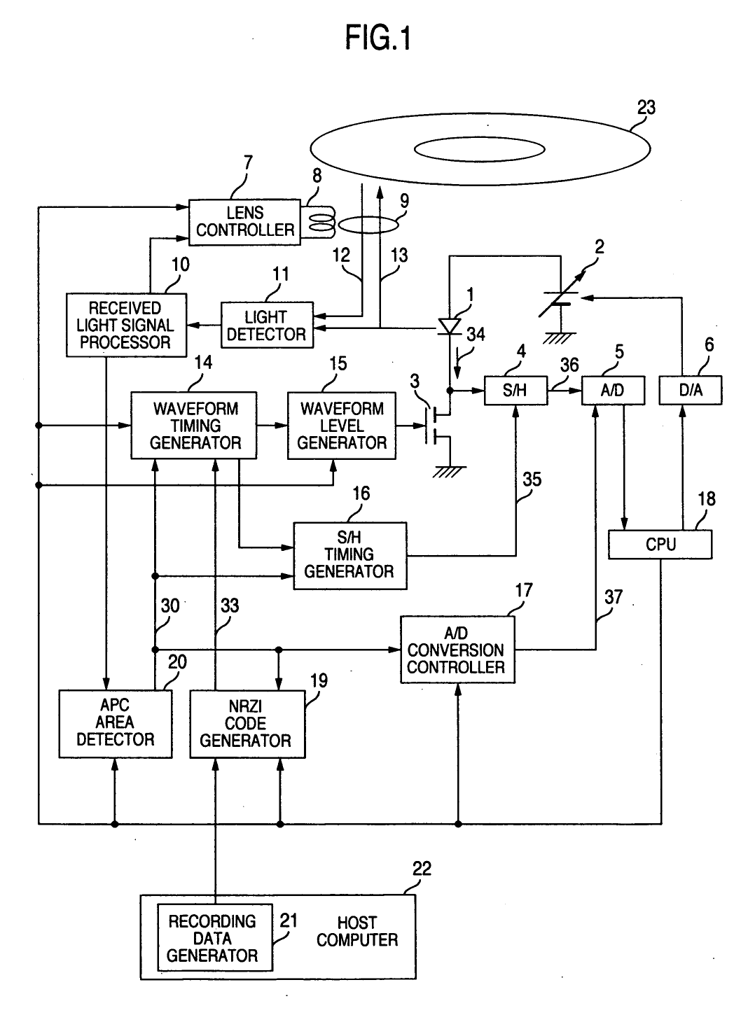

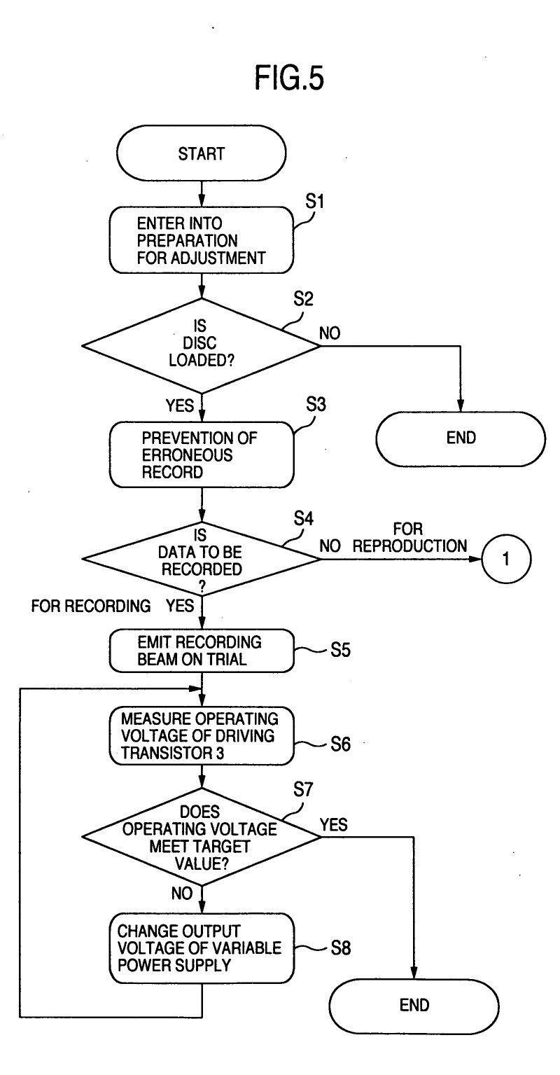

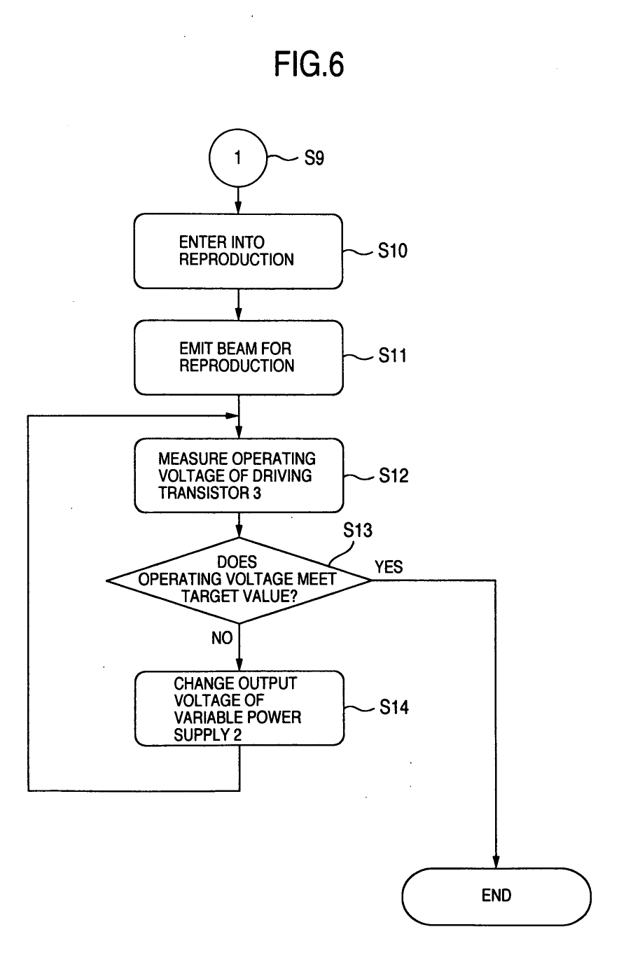

The first embodiment of the present invention concerns with the operation of adjusting an operating voltage of a driving transistor before starting recording of data or the like, which will be described with reference to FIGS. 1, 5 and 6. FIG. 1 is a schematic block diagram showing an optical disk recording/reproducing apparatus according to the present invention. FIGS. 5 and 6 show the operation flowchart of a laser driving circuit included in the optical disk recording/reproducing apparatus.

As shown in FIG. 1, the laser driving circuit according to the first embodiment of the invention includes a laser diode 1 for emitting a recording and reproducing beam, a variable power supply 2 for generating a laser driving power to be used for driving the laser diode 1, a driving transistor 3, a S/H (sample-and-hold circuit) 4, an A/D converter 5, and a D/A converter 6. The laser diode 1, the variable power supply 2 and the driving transistor 3 are connected in series. The S/H 4 operates to sample and hold a voltage between a drain terminal and a source one, which voltage corresponds to the operating voltage of the driving transistor 3. The S/H 4 is connected with the A/D converter 5, from which the A/D converted signal is inputted as a digital value into a CPU 18.

The CPU 18 operates to convert the detected voltage value into a control value and to set the converted value to the D/A converter for performing the digital-to-analog conversion so as to control the output voltage of the variable power supply 2. The variable power supply 2 keeps the same output voltage until the set value of the D/A converter 6 is changed. The operating voltage of the driving transistor 3 corresponds to a value derived by subtracting a voltage drop caused by the laser diode 1 from the output voltage of the variable power supply 2. As such, by controlling the output voltage of the variable power supply 2, it is possible to control the operating voltage of the driving transistor 3.

As shown in FIG. 5, the CPU 18 performs the suitable setting operation to adjusting the operating voltage of the driving transistor 3 in a step S1 of preparing the adjusting operation.

Then, the process is executed to check for an insertion and mount of an optical disc 23, that is, the so-called loading operation. If the optical disc 23 is loaded, the CPU 18 operates to perform a setting process S3 of preventing erroneous recording to be brought about when the laser diode 1 is caused to emit a laser beam. In this process 3, it is possible to refer to the method of causing a lens controller 7 to lower a lens position and shift the focus out of a recording layer or the method of shifting a head position to a non-recording area. If the lens controller 7 is caused to lower the lens position so that the focus is shifted out of the recording layer, it is preferable to rotate the optical disc 23. This makes it possible to prevent unfavorable recording of data on a recording layer caused by emitting an unfocused laser beam onto one spot on the recording layer for a certain length of time.

Going to a step S4, it is determined if the recording operation is necessary. For example, when the apparatus is turned on or when the temperature is changed far more than the temperature of the previous adjustment, if the optical disc 23 being loaded is recordable, it is determined that the recording operation is necessary (Y). If it is not necessary (N), the process illustrated in FIG. 6 will be executed. This process will be discussed later.

Turning to FIG. 1, the combination of a NRZI (Non-Return-Zero-Inverted) code generator 19, a waveform timing generator 14, a waveform level generator 15 and a driving transistor 3 operates to steadily generate a laser current of a square waveform to be used for trial light emission. The laser current of the square waveform is supplied to the laser diode 1 so that the laser diode 1 may emit a laser beam for trial recording (step S5 in FIG. 5). The luminous factors in this trial light emission are an emission period, a duty and an emission power. The emission period and the duty are set as the values to be derived by an emission time limitation of the laser diode 1 and a sampling performance of the S/H 4. The emission power is set as a power required for recording data on the optical disc 23 or a specified value. The emission power is measured by a front monitor located in a light detector 11. Based on the value measured by the front monitor, the output current is changed as keeping the output voltage of the variable power supply 2 stationary so as to adjust and set the emission power to a desired power.

The S/H timing generator 16 causes the S/H 4 to periodically sample the signal on the timing when the emission power reaches a target value and to hold the signal on the other timing. After the operation is made stable a specified time later, the A/D conversion controller 17 operates to generate a conversion timing and send it to the A/D converter 5. Then, on this timing, the A/D converter 5 converts the signal sent from the S/H 4 into the corresponding digital signal. The digital signal is sent to the CPU 18. The CPU 18 measures the operating voltage of the driving transistor 3 (step S6).

The CPU 18 compares the operating voltage of the driving transistor 3 with a target value with an allowable error and determines if the operating voltage stays in the target value range (step S7). If the target value is met, the process is finished (step S13).

On the other hand, if the operating voltage stays in the target value range, the CPU calculates a control value and sets it to the D/A converter 6. The D/A converter 6 generates an analog voltage corresponding with the control value and changes the output voltage of the laser driving power supply, which corresponds to an output of the variable power supply 2. This change results in adjusting the operating voltage of the driving transistor 3 (step S8).

Then, again, the process goes back to the step (S6), in which the operating voltage of the driving transistor 3 is measured, and then starts the loop.

After the adjustment is finished, the CPU 18 does not change the set value of the D/A converter 6, so that the variable power supply can keep the same output voltage. This operation makes it possible to obtain a suitable supply voltage for driving the laser diode.

If the optical disc 23 being loaded is a reproduction-only medium or the optical disc recording/reproducing apparatus is a playback-only apparatus, only the reproducing (playback) operation is made possible. Hence, the supply voltage for driving the laser diode just requires a lower voltage than the supply voltage required when recording data on the optical disc 23. In this case, the process for adjusting the supply voltage for driving the laser diode to be a reproduction-only voltage will be described with reference to the step S9 of FIG. 6, to which the process is jumped from N of the step S4 in FIG. 5, and the subsequent steps.

The CPU 18 performs the required settings for adjusting the suitable operating voltage of the driving transistor 3 to the generation of a reproducing laser beam (step S10). The waveform level generator 15 and the driving transistor 3 operate to generate a reproducing laser current 34 so as to cause the laser diode to emit the reproducing beam (step S11). In the reproducing operation, since the laser beam 13 keeps a constant emission power, the laser current 34 is made constant. Hence, the voltage between the drain and the source of the driving transistor 3 is made constant accordingly. This voltage is steadily gated into the S/H 4 in which the voltage is sampled. Then, the S/H 4 generates an S/H output 36.

Then, a certain length of time later, the A/D converter 5 converts the S/H output 36 into the corresponding digital signal. The digital signal is read by the CPU 18. Hence, the operating voltage of the driving transistor 3 is recognized by the CPU (step S12). If an HF (High Frequency) signal is used, the operating voltage of the driving transistor 3 is made variable depending upon the HF signal. In order to overcome this variety, the method has been proposed in which a voltage is grasped at a peak of the HF current or an average value of the variable voltages is measured and an allowance is added to the average value.

The CPU 18 compares the operating voltage of the driving transistor 3 with a target value (step S13). If the former meets the latter, the process is finished. If not, the CPU calculates a control value and sets it to the D/A converter 6. The D/A converter 6 generates the analog voltage corresponding with the control value and sends the analog voltage to the variable power supply 2. In response to the analog voltage, the output voltage of the variable power supply 2 is controlled in order to change the operating voltage of the driving transistor 3 (step S14).

In a case that this embodiment is applied to the optical disk driving apparatus arranged to use a blue-violet laser diode, if a high driving voltage is required, for example, when the temperature of the laser diode 1 is low in starting the operation, the supply voltage for driving the laser may be adjusted to be a higher voltage. The driving transistor enables to obtain a sufficiently high operating voltage. Further, when the temperature of the laser diode is high, the supply voltage for driving the laser may be adjusted to be a lower voltage, which leads to reducing the overall power consumption.

The CPU 18 may store the values obtained in the steps S6 to S8 and the steps S12 to S14 in an internal memory therein and then may be temporarily stopped. The values may be used as the initial values in the next adjustment.

After this adjustment, the operation of the main purpose, that is, the record of data on the optical disc or the reproduction of data from the optical disc is started.

### Embodiment 2

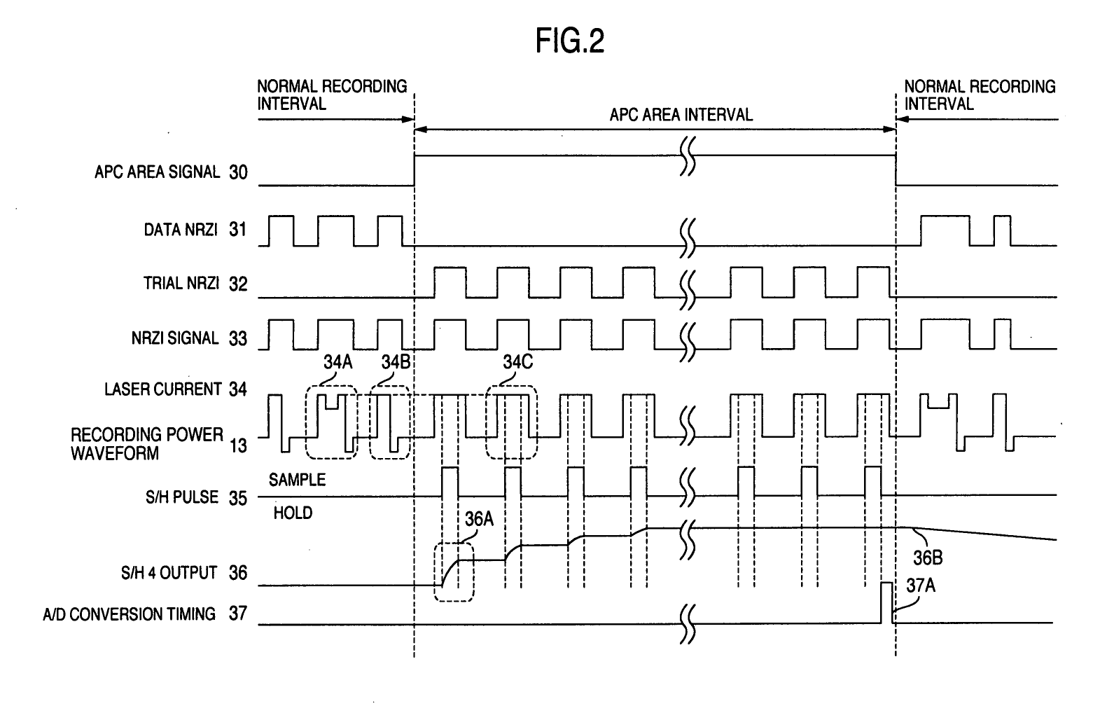

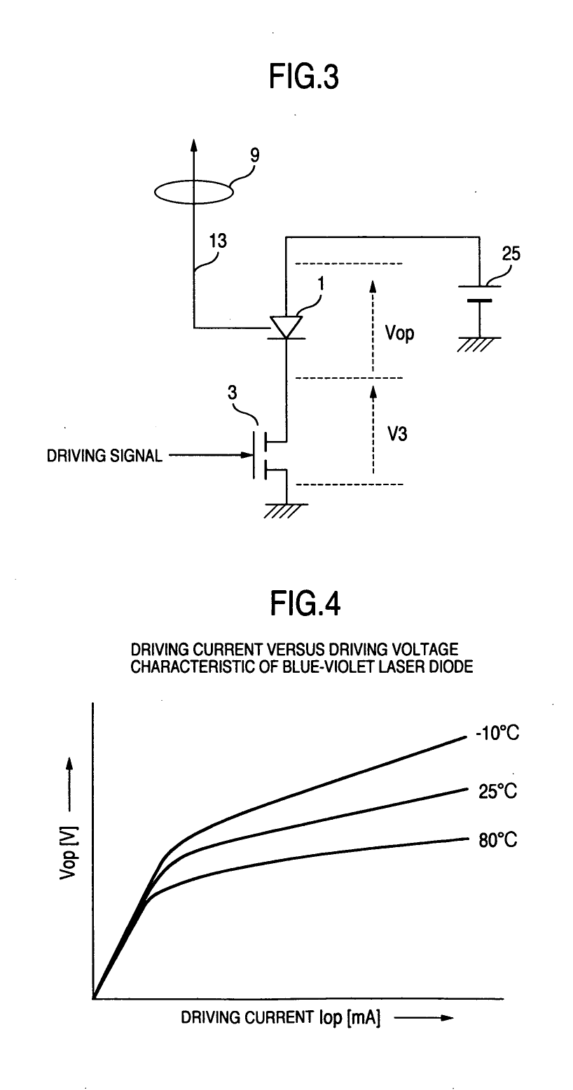

The second embodiment of the present invention concerns with the operation of measuring and adjusting the operating voltage of the driving transistor 3 in recording operation. This operation will be described with reference to FIGS. 1 and 2. FIG. 2 shows the operation waveforms of various kinds of signals in the normal recording interval and in the APC (Auto Power Control) area interval.

In the normal recording operation, the recording data is sent from the host computer 22 to the NRZI code generator 19 together with the management data, the synchronous signal and so forth. In the NRZI code generator 19, all the data are converted into the NRZI codes and then are inputted into the waveform timing generator 14. The waveform timing generator 14 generates the timings of the recording beam waveform according to the NRZI codes. Then, the waveform level generator 15 determines the level of each timing, on which the recording waveform is generated. Then, the driving transistor 3 and the laser diode 1 generate a laser beam 13 in concert. Though the laser beam 13, a mark/space is written on the recording area of the optical disc 23.

At a time, a reflected beam 12 is received by the light detector 11 and then is inputted into a received light signal processor 10. The processor generates a control signal for a lens position adjusting servo and inputs the control signal into a lens controller 7. The lens controller 7 controls the position and the angle of a lens 9 through a pickup coil 8. Further, the received light signal processor 10 detects the radiated positions of the recording beam as the addresses and the areas on the optical disc 23.

Then, an APC area detector 20 detects if the radiated position of the laser beam 13 is in the calibration area like the APC area that is permitted to be freely used by the optical disc recording/reproducing apparatus and outputs the detected result as an APC area signal 30. Though in the normal interval the NRZI code generator 19 generates the data NRZI 31 according to the data sent from the recording data generator 21, in the APC area interval, the NRZI code generator 19 switches the generation of the data NRZI 31 into the generation of the trial NRZI 31 and then outputs the trial NRZI 31. This trial NRZI 31 may have an optional pulse width. Hence, the pulse width of the trail NRZI 31 may be set as the width to be easily processed by the S/H 4 located at a later stage.

Then, the waveform timing generator 14, the waveform level generator 15 and the driving transistor 3 generate a laser driving current 34 in concert. In the normal interval, the recording pulses 34A and 34B where the start and the end of the pulse become pulse peaks are generated. These pulses are suitable to data recording.

In the APC area interval, the square recording pulse 34C is generated. In the pulse 34C, the peaks of the recording pulses 34A and 34B are kept. The recording pulse 34C is formed by changing the emission pulse waveform so that the recording pulse 34C may be more easily processed by the S/H 4 located at a later stage. This is permissive because no limitation is normally given to the writing data in the APC area.

At a time, the waveform timing generator 14 and the S/H timing generator 16 generate an S/H pulse 35 according to the flat portions of the square waveform pulse 34C. The S/H pulse 35 causes the S/H 4 to perform the sampling operation. As indicated in the rise portion 36A of the output 36 of the S/H 4, in the fast operation, the sampling pulse may be made so thin that an accurate hold voltage cannot be obtained by one sampling. However, by performing a plurality of samplings, the S/H 4 enables to output an accurate and stable value of 36 B.

The A/D conversion controller 17 generates an AD conversion timing pulse 37A in the APC area interval where the S/H 4 generates a stable output or after the APC area is finished. On this timing, the A/D converter 5 generates the digital signal, which is read by the CPU 18. This allows the operating voltage of the driving transistor 3 to be detected by the CPU.

The CPU 18 compares the operating voltage of the driving transistor 3 with a target value, calculates a control value based on the compared result, and sets the control value to the D/A converter 6. The D/A converter 6 generates the corresponding analog voltage with the control value. According to the analog voltage, the output voltage of the variable power supply 2 is changed and the operating voltage of the driving transistor 3 is changed accordingly. By performing this operation repetitively until the operating voltage of the driving transistor 3 meets the target value, the operating voltage of the driving transistor 3 can be adjusted.

At this time, if the operating voltage of the driving transistor 3 is changed, the laser driving current 34 is slightly changed according to the characteristic of the transistor. Hence, the emission power of the laser beam 13 may be changed. In order to avoid this adverse effect, it is possible to use the following methods in which the adjustment of the operating voltage of the driving transistor 3 is combined with the power control of the beam 13.

As one method, the adjustment of the operating voltage of the driving transistor 3 is executed alternately with the power control of the beam 13. That is, in the nth APC area interval, the operating voltage of the driving transistor 3 as shown in FIG. 2 is detected. It is then determined if the detected operating voltage meets the target value with an allowable error. If not, the output voltage of the variable power supply 2 is changed slowly during the specified time. After this operation is finished, in the next (n+1)th APC area interval, the power of the laser beam 13 is detected. The detected power is compared with the target value with an allowable error. It is then determined if the detected power meets the target value. If not, the power set value with a deviation shifted to the target value is set to the waveform level generator 15 and the current value of the variable power supply 2 is adjusted so that the power of the laser beam 13 may be adjusted. The adjustment of the output voltage of the variable power supply and the adjustment of the power of the laser beam 13 are repetitively executed until both the output voltage and the power meet the target value.

As another method, after a proper set value is checked, the set value is reflected in the normal recording interval. That is, in the n-th APC area interval, the operating voltage of the driving transistor 3 as shown in FIG. 2 is detected. In this stage, only the detection is executed and the output voltage of the variable power supply is not changed according to the operating voltage.

Immediately before the next (n+1)th APC area interval, the output voltage of the variable power supply 2 is changed according to the control value calculated by the CPU based on the operating voltage detected in the nth APC area interval. Then, the power of the outgoing beam 13 is measured by the light detector 11 including the front monitor in order to obtain the change of the power according to the change of the operation of the driving transistor 3. Next, at a time when the (n+1)th APC area interval is finished, the output voltage of the variable power supply 2 is returned to the value before the change in order to avoid the adverse effect on the just subsequent recording operation. Then, the measured power is compared with the target power and the desired power set value is calculated on the compared result. By these operations, the proper output voltage of the variable power supply and the proper set value are obtained in advance. In the next (n+2)th APC area interval, the output voltage and the power set value are set to the variable power supply at a time. This makes it possible to stably control the power of the laser beam 13.

In the foregoing operation, in the (n+2)th APC area interval, the output voltage and the power of the variable power supply are set. Instead, after the (n+1)th APC area interval is finished, it is possible to derive the power set vale of the variable power supply, set the proper output voltage and power set value to the variable power supply, and then carry out the recording operation immediately after the (n+1)th APC area interval.

### Embodiment 3

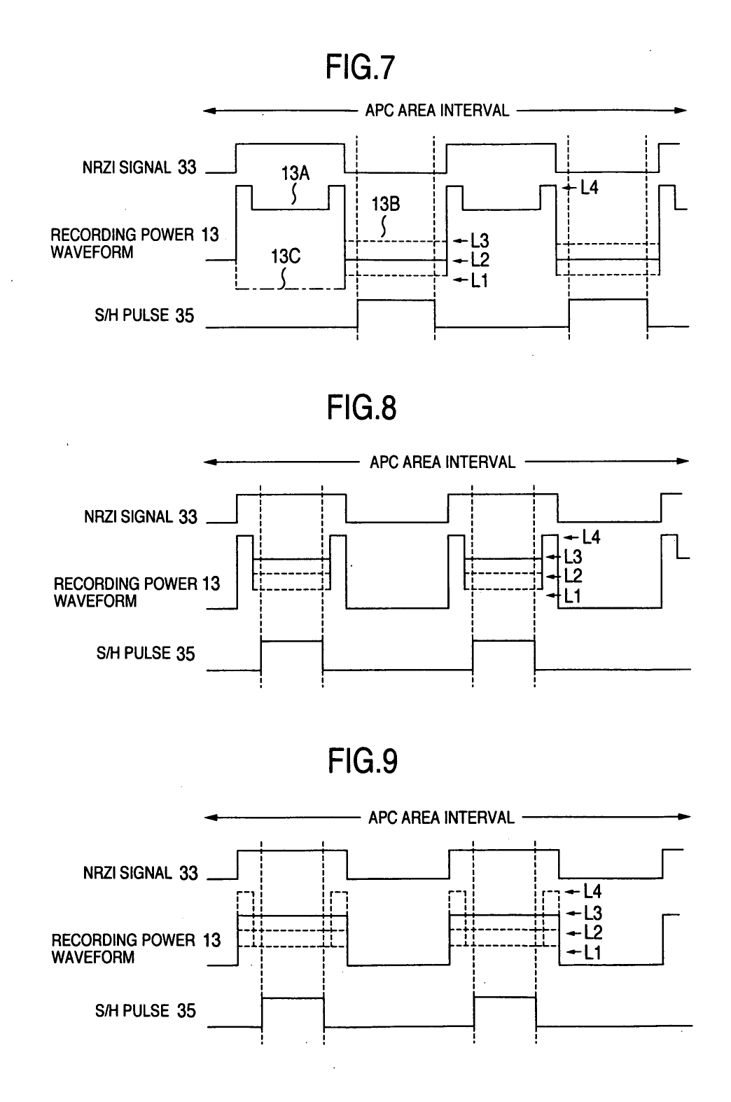

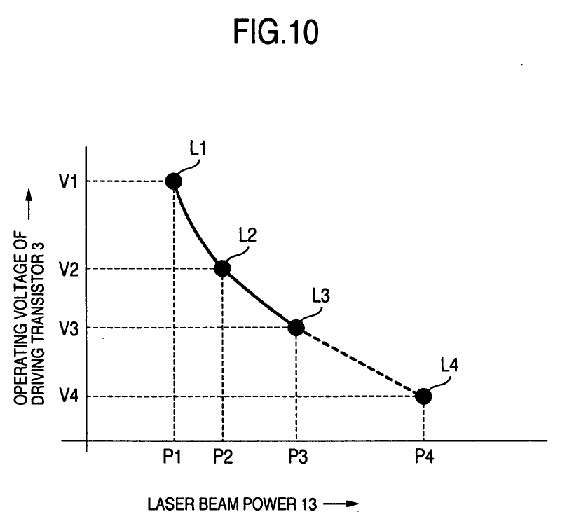

The third embodiment of the invention will be described with reference to FIGS. 1, 7 and 10. FIG. 7 shows the relation among a NRZI signal, a recording emission power waveform and an S/H pulse waveform. The operation waveforms shown in FIG. 7 correspond to the operations to be executed in the APC area interval shown in FIG. 2. FIG. 10 is a graph showing an operating voltage of the driving transistor 3, which is measured as changing a laser current 34 or a laser beam 13 for recording.

The description will be oriented to the operation to be executed periodically in the APC area interval and when recording data on an optical disc in the optical disc recording/reproducing apparatus arranged as shown in FIG. 1.

In the APC area interval, the NRZI code generator 19 generates a trial NRZI signal 32 with a pulse width to be easily processed by the S/H 4 located at a later stage and switches the NRZI signal to the trial NRZI signal 32. Then, the trial NRZI signal is outputted as the NRZI signal 33 to the waveform timing generator 14. Then, the waveform timing generator 14, the waveform level generator 15, the driving transistor 3 and the laser diode 1 are served to generate the recording beam 13 in concert. For the mark portion, a recording pulse 13A is generated even in the APC interval. The recording pulse 13A is suitable to the same fast recording as the recording in the normal recording interval and has a concave (castle) form in a manner that peaks appear at the start and the end of the pulse.

If the optical disc 23 is a rewritable type, the erase power beam is generated, while if the optical disc 23 is a write-once type, the read power beam is generated. In the space portion 13B, the beam is emitted, for example, at a power P1 indicated by L1 in the nth APC area interval, a power P2 indicated by L2 in the (n+1)th APC area interval, and a power P3 indicated by L3 in the (n+2)th APC area interval. The emission powers are checked by the light detector 11 like the front monitor and adjusted to proper values. In the normal recording interval other than the APC area interval, the emission power for the space portion 13b is returned to an ordinary value of P2 indicated by L2 (not shown).

The S/H timing generator 16 operates to generate the S/H pulses 35 that are suitable to sampling the operating voltages of the driving transistor 3 at the L1 spot, the L2 spot and the L3 spot. Then, the S/H pulses 35 are A/D converted by the A/D converter 5 and then are taken by the CPU 18.

The relation between the operating voltage of the driving transistor 3 and the emission power of the recording beam 13 at each point of L1, L2 and L3 is shown in the graph of FIG. 10.

As shown in FIG. 10, at the measurement point L1 where the beam power is as low as P1, the laser driving current 34 is small and the driving voltage of the laser diode 1 is low accordingly, so that the operating voltage of the driving transistor 3 becomes as high as V1. Going on the curve from the measurement points L2 to L3, the beam power is rising from P2 to P3 and the laser driving current 34 becomes larger accordingly, so that the driving voltage of the laser diode 1 is made higher. Hence, the operating voltage of the driving transistor 3 is lowering from V2 to V3 accordingly.

On the extension of the curve of the graph shown in FIG. 10 containing the measurement points of L1 to L3, a point of L4 can be obtained by an approximated curve. By letting the beam power P4 at the point L4 be a target peak power (L4 spot of FIG. 7) of the recording beam 13, it is possible to obtain the operating voltage V4 of the driving transistor 3 in the necessary peak power. The value of V4 is compared with a target value so as to calculate a control value based on the compared result. The control value is set to the D/A converter 6. This causes the output voltage of the variable power supply 2 to be changed and the operating voltage of the driving transistor 3 to be changed. By executing these series of operations a plurality of times until the value of V4 meets the target value, the operating voltage of the driving transistor 3 can be adjusted to a proper value.

In the embodiment in which the operation shown in FIG. 7 is executed, the mark spot 13A is not used. Hence, the emission power may be made lower as indicated by 13C. Further, the emission power may be made to be a power L2 (P2) of the ordinary space portion or a lower power L1 (P1) than the power L2. This arrangement allows the emission of the laser diode 1 to avoid the obstacles (in which some limitations are caused in switching to the DC operation or an average of the emission power becomes too large).

In the foregoing description, the operation shown in FIG. 7 has been carried out with respect to the space portion 13B of the NRZI signal 33. Instead, if the operating condition of the S/H 4 is met, the operation may be carried out with respect to the mark portion 13A of the NRZI signal 33. The two operations thereabout will be described with reference to FIGS. 8 and 9.

In FIG. 8, the operating voltage of the driving transistor 3 is measured as changing the emission power of the central portion of the concave in the mark portion of the recording power waveform 13 from L1 to L2 to L3. The changing timing and the adjusting operation of the operating voltage of the driving transistor 3 are the same as those having been described with reference to FIG. 7.

Turning to FIG. 9, though the recording power waveform 13 has a concave mark portion in the normal recording interval, only in the APC area interval, the peak powers at the start and the end of the pulse are leveled to the same power as the power of the central portion in a manner that the recording power waveform 13 is made square. The changing operation of the emission power from L1 to L2 to L3 and the adjusting operation of the operating voltage of the driving transistor 3 are the same as those having been described with reference to FIG. 7 or FIG. 8.

The use of this embodiment makes it possible to reduce the effective emission power in the APC area interval more than the power in the normal recording interval. This leads to lessening the burden put on the optical disc 23 or the laser diode 1.

In a case that a laser driving circuit or an optical disc recording/reproducing apparatus is arranged to use a red laser diode or a near infrared laser diode, this embodiment may be applied to the circuit or the apparatus. Further, the embodiment may be also applied to the circuit arrangement having components connected in reverse sequence, that is, in the sequence of the variable power supply 2, the driving transistor 3, the laser diode 1 and the GND.

Moreover, immediately before or at the same time when the normal writing operation is interrupted, that is, the walking OPC or the walking APC is executed, it is possible to execute the measurement of the operating voltage of the driving transistor and the adjustment of the variable power supply according to the present invention.

In a case that the optical disc 23 is divided into plural recording zones, the disc speed and the emission power are changed in switching a recording area from one recording zone to another. Immediately before and at the same time when the change is performed, it is also possible to execute the measurement of the operating voltage of the driving transistor 3 and the adjustment of the variable power supply 2 according to the present invention.

By measuring the operating voltage of the driving transistor 3 and adjusting the supply voltage of the variable power supply 2 when manufacturing the optical recording/reproducing apparatus or turning on the apparatus, it is possible to grasp the relation between the emission power and the most corresponding output voltage of the variable power supply 2 in advance. The relation grasped in advance makes it possible to obtain the proper initial value to the measurement to be executed when the optical disc 23 is loaded to the apparatus or when the data recording is started.

Before starting the recording, it is possible to estimate the operating voltage of the driving transistor 3 for the target emission power by using the approximated curve derived from the measurement points.

As set forth above, the laser driving method and the optical disk recording/reproducing apparatus according to the present invention make it possible to secure the operating allowance of the driving transistor 3 even immediately after starting the recording and thereby to keep the operation of the driving transistor 3 stable.

Further, when the laser diode 1 is caused to emit a beam at a high power in adjusting the laser emission power, it is necessary to prevent data or the like recorded on the optical disc from being impaired. As stated above, according to the present invention, even when the optical disk is loaded to the apparatus, it is possible to prevent the recording layer of the disc from being impaired when the laser diode 1 is caused to emit a beam on trial. Further, even during the operation of recording data onto the optical disk, it is also possible to prevent the adjacent track to the track on which a beam spot is radiated from being impaired or adversely effected when the laser diode 1 is caused to emit a beam on trial.

Moreover, to make the life of the laser diode 1 as long as possible, it is necessary to keep the beam emission condition within the regulated condition. According to the present invention, it is possible to keep the emission power of the laser diode and the pulse width of the laser beam equal to or lower than the predetermined value when the laser diode is caused to emit a beam on trial. This makes it possible to avoid the adverse effect on the life of the laser diode.

The present invention is capable of keeping the laser diode stably operated before starting the recording and thereby stably writing data on an optical disk.

It should be further understood by those skilled in the art that although the foregoing description has been made on embodiments of the invention, the invention is not limited thereto and various changes and modifications may be made without departing from the spirit of the invention and the scope of the appended claims.

1. A laser driving method of driving a laser driving circuit having a laser diode for emitting a laser beam onto an optical disc, a transistor connected in series with the laser diode, and a variable power supply for applying a DC voltage to the laser diode, comprising the steps of:
causing the laser diode to emit a laser beam on trial before starting recording of data onto the optical disc;
detecting an operating voltage of a contact between the laser diode and the transistor; and
adjusting a DC voltage of the variable power supply based on the detected operating voltage.

2. The laser driving method as claimed in claim 1, wherein in the trial beam emission step, the laser diode is caused to emit a laser beam so that no data is recorded on the optical disc.

3. The laser driving method as claimed in claim 1, wherein in the detection step, the operating voltage is detected on a specified timing by using sample-and-hold means.

4. The laser driving method as claimed in claim 1, wherein in the trial beam emission step, if the optical disk is located on a light path of a laser beam emitted from the laser diode, the focus of the laser beam is shifted out of a recording layer of the optical disc and the spot onto which the laser beam is emitted is moved to a non-recording area of the optical disc.

5. The laser driving method as claimed in claim 4, wherein while the focus of the laser beam is shifted out of the recording layer of the optical disc, the optical disc is caused to rotate.

6. The laser driving method as claimed in claim 1, further comprising:
a first driving step of causing the laser diode to be driven on a first driving current waveform when a spot onto which the laser beam is emitted is in a first area of the optical disc during the recording of data onto the optical disc; and
a second driving step of causing the laser diode to be driven on a different second driving current waveform from the first current waveform when a spot onto which the laser beam is emitted is in the second area of the optical disc during the recording of data onto the optical disc, and the second driving step having a step of detecting a voltage on a contact between the laser diode and the transistor.

7. The laser driving method as claimed in claim 1, wherein in the trial beam emission step, the laser diode is caused to emit a laser beam at lower powers than a recording power required in recording data on the optical disk and in the detection step, for each of the powers, the operating voltage on the contact is detected and the operating voltage on the contact corresponding with the target power is derived by using an approximated curve.

8. The laser driving method as claimed in claim 1, further comprising the step of detecting an emission power of the laser beam emitted from the laser diode, the emission power detecting step including a power adjusting step of adjusting the emission power by adjusting an output current of the variable power supply based on the detected power, and the operations of the voltage adjusting step and the power adjusting step being executed alternately with each other.

9. The laser driving method as claimed in claim 1, further comprising the step of deriving an optimal emission power of the laser diode after obtaining an optimal set value of the voltage to be applied by the variable power supply, and wherein the optimal set value of the applied voltage and the optimal emission power are reflected at a time when recording data on the optical disc.

10. The laser driving method as claimed in claim 1, wherein in the trial beam emission step, before starting a reproducing operation, the laser diode is caused to emit a laser beam on trial at a power required for the reproducing operation and then the detection step and the voltage adjusting step are executed.

11. A laser driving method for a laser driving circuit having a laser diode for emitting a laser beam onto an optical disc, a transistor connected in series with the laser diode and a variable power supply for applying a DC voltage onto the laser diode, comprising:
a first driving step of causing the laser diode to be driven on a first driving current waveform when a spot onto which the laser beam is emitted is in a first area of the optical disc during recording of data onto the optical disc; and
a second driving step of causing the laser diode to be driven on a different second waveform from the first driving current waveform when a spot onto which the laser beam is emitted is in a second area of the optical disc, and the second step further including a step of detecting a voltage on a contact between the laser diode and the transistor.

12. An optical disc recording/reproducing apparatus for recording and reproducing data onto and from an optical disk, comprising:
recording and reproducing means having a laser diode for emitting a laser beam onto the optical disc;
a power supply for applying a DC voltage onto the laser diode;
a transistor being connected with the laser diode;
detecting means for detecting an operating voltage applied between the transistor and the laser diode; and
a control unit for controlling the recording and reproducing means, the power supply and the detecting means; and wherein
the control unit controls the power supply so that the laser diode is caused to emit a laser beam on trial at a predetermined voltage before starting recording of data onto the optical disc and further adjusts a DC voltage of the power supply based on an operating voltage detected by the detecting means.

13. The optical disc recording/reproducing apparatus as claimed in claim 12, wherein the control unit controls the power supply so that no data can be recorded on the optical disc through the laser beam emitted on trial.

14. The optical disc recording/reproducing apparatus as claimed in claim 12, wherein the detecting means includes sample-and-hold means and the sample-and-hold means detects the operating voltage on a specified timing.

15. The optical disc recording/reproducing apparatus as claimed in claim 12, wherein the control unit controls the recording and reproducing means so that when the optical disk is located on a light path of the laser beam emitted from the laser diode, the focus of the laser beam is shifted out of a recording layer of the optical disc or a spot onto which the laser beam is emitted is moved to a non-recording area of the optical disc.

16. The optical disc recording/reproducing apparatus as claimed in claim 15, wherein the control unit controls the recording and reproducing means so that the focus of the laser beam is shifted out of a recording layer of the optical disc and the optical disc is caused to rotate.

17. The optical disc recording/reproducing apparatus as claimed in claim 12, wherein during recording of data onto the optical disc, the laser diode is caused to be driven on a first driving current waveform when a spot onto which a laser beam is emitted is in a first area of the optical disc or on a different waveform from the first driving current waveform when a spot onto which the laser beam is emitted is in a second area and while the laser diode is caused to be driven on the second waveform, the detecting means is served to detect a voltage applied on a contact between the laser diode and the transistor.

18. The optical disc recording/reproducing apparatus as claimed in claim 12, wherein the control unit controls the power supply so that the laser diode is caused to emit a laser diode at lower powers than a recording power required in recording data on the optical disc, the detecting means detects an operating voltage applied on the contact at each of the powers, and the control unit derives the operating voltage applied on the contact corresponding with the target power by using an approximated curve.

19. The optical disc recording/reproducing apparatus as claimed in claim 12, further comprising light detecting means for detecting a power of a laser beam emitted from the laser diode, and wherein the control unit controls the power supply so that the power supply adjusts an output current and the emission power accordingly, based on the power detected by the light detecting means.
